(19) United States
(12) Patent Application Publication
(10) Pub. No.: US 2005/0096098 A1
(43) Pub. Date: May 5, 2005

(54) Wireless telephone system for electrically powered wheelchair

(76) Inventor: Michael R. Woods, Macomb, MI (US)

Correspondence Address: YOUNG & BASILE, P.C., 3001 WEST BIG BEAVER ROAD, SUITE 624, TROY, MI, 48084, US

(21) Appl. No.: 11/011,904

(22) Filed: Dec. 14, 2004

Related U.S. Application Data
(63) Continuation-in-part of application No. 10/132,416, filed on Apr. 25, 2002.

(51) Int. Cl. H04M 1/00

(52) U.S. Cl. 455/569.1; 455/569.2

(57) ABSTRACT

A cellular or cordless telephone system with hands-free voice-activated features is mounted to and carried by an electrically powered wheelchair. A triggering device such as a toggle type push button switch or a voice-command input microphone/amplifier is mounted on the outside of the left armrest to arm the system to initiate and terminate calls. A microphone is mounted in the left armrest and the speaker is mounted under the right armrest of the chair. The telephone system is powered by one or both of the 12-volt batteries used to supply drive power to the chair.

### CROSS-REFERENCE TO RELATED APPLICATION

This application is a continuation-in-part of U.S. Ser. No. 10/132,416, filed Apr. 25, 2002, and claims priority thereto.

### FIELD OF THE INVENTION

This invention relates to wireless telephones and more particularly to the combination of an electrically powered wheelchair with a voice-activated wireless telephone having essentially hands-free capability. The term “wireless” is used herein to include both cordless and cellular telephones.

### BACKGROUND OF THE INVENTION

Cellular and cordless telephones have provided many people with a new dimension in telephonic communication. The use of conventional cellular and cordless telephones, however, requires a high degree of manual dexterity and fine motor control to manipulate small buttons and/or “flip” components to activate or “power up” the telephone as well as to make, receive and terminate calls. This effectively denies many handicapped persons the unassisted use of all telephones, whether wireless or otherwise.

The problem is alleviated to some degree by the use of the so-called “hands-free” and voice-activated features of modern telephones. The hands-free operation is provided by an external microphone and an external speaker, either or both of which can be incorporated into a headset or mounted in free-standing housings. Voice-activated dialing extends and enhances the advantages of hands-free operation by allowing the user to select an outgoing call number simply by uttering voice commands.

Overall, hands-free features do not solve the problem of handicapped persons having little or no use of the hands and fingers; i.e., a conventional handset of any kind, even with hands-free and voice-activated features, requires the manipulation of a push button or hinged structure on the telephone body to activate or turn the phone on in preparation for making, receiving or terminating a call.

### SUMMARY OF THE INVENTION

The present invention, in essence, provides wheelchair occupants with wireless telephonic communication capability by eliminating the need for the manipulation of small, telephone-mounted push buttons and other telephone activating elements such as “flip” covers which require fine motor control through the use of hands and fingers. The invention further ensures long periods of uninterrupted telephone usage without fear of encountering a low-battery condition.

In essence, the invention achieves these objectives by combining elements of a state-of-the-art wireless telephone of either cellular or cordless type with hands-free and voice-activated capabilities, and further with wheelchair structure including the batteries which are used to power the dc drive of a powered chair. The invention solves the problem associated with a loss of normal dexterity by providing a “trigger” function to initiate or terminate a call via either a relatively large, toggle-type push button activation switch or an audio response system to condition the telephone for normal operation through the conventional hands-free system. The toggle switch is separate from the telephone itself, is much larger than the push buttons on conventional cell phones, and can be mounted on the chair where it can be easily accessed by a part of the body over which the chair occupant has normal or nearly normal movement control. For example, the toggle switch may be mounted on an armrest facing to the outside or on a headrest where head movement can trigger it. Alternatively, an audio “trigger” signal can be generated by an audible voice command to activate the hands-free system to receive further dialing instructions.

In a first embodiment of the invention described herein for purposes of illustration and not by way of limitation, the trigger switch is a spring biased push button mounted on the outside of the armrest of an electrically powered chair, preferably the same armrest on which a joystick or the like is mounted for maneuvering control. By placing the toggle switch on the same armrest with the maneuvering control, it is assured that the switch is associated with the arm over which the chair occupant has a higher degree of movement control.

By connecting the telephonic system to one or both of the large drive power batteries of the chair, the trigger system may be left on for virtually indefinite periods of time and the user is relieved of the concern for the low battery conditions which are frequently associated with wireless telephones having small internal metal hydride batteries. Recharging the chair driver batteries recharges the telephone power supply as well.

In a second embodiment of the invention, a conventional cordless telephone such as a Uniden EXP 3241 is modified to receive a voice “trigger” signal to condition the base components for voice-activated dialing. The microphone and speaker of the handset are preferably mounted on the wheelchair as in the cellular embodiment.

Summarizing, the present invention provides at least the following advantages:
1. the user of the wireless telephone is able to “trigger” the system to become ready to initiate, receive and terminate calls by movement of a large body part such as an arm or by a voice command;

2. the telephone is powered by a large capacity power source providing essentially unlimited use time; and
3. the entire system can be assembled and wired from conventional, commercially available components.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a perspective view of an electrically powered wheelchair equipped with a cell phone in accordance with the present invention;

FIG. 2 is a front view of the wheelchair of FIG. 1;

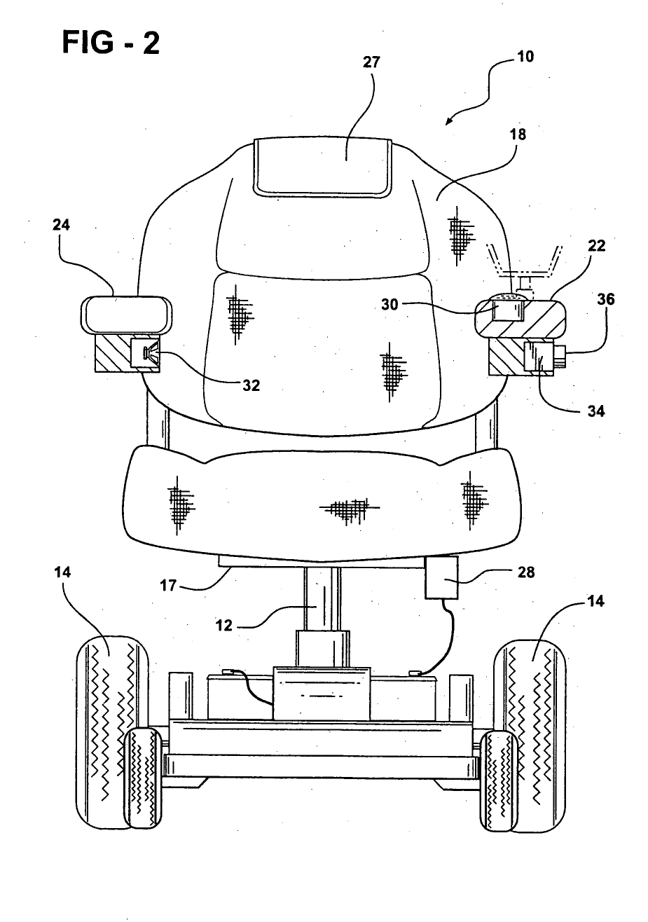

FIG. 3 is a schematic wiring diagram of the cellular telephone system incorporated into the wheelchair of FIGS. 1 and 2;

FIG. 4 is a schematic diagram of a cordless phone system utilizing the invention; and

FIG. 5 is a flow chart of software for the system of FIG. 4.

### DESCRIPTION OF THE ILLUSTRATIVE EMBODIMENT

Referring to the drawing, an electrically powered wheelchair 10 is shown to comprise a frame 12 supported on opposed drive wheels 14 and castered rear wheels 15. A 24-volt electric drive 13 is powered by two 12-volt automotive batteries 16 connected in series. Occupant accommodations include a padded seat 17 attached to an adjustable backrest 18. A joystick control 20 is mounted on the forward end of a left armrest 22. A right armrest 24 is mounted on the opposite side of the backrest 18 and frame 12.

The joystick control 20 is of the cradle-type and requires that the occupant/driver of the chair 10 has control over movement of the left arm thereby to make direction and speed maneuvering inputs to the chair drive through the cradle-type joystick 20. Such inputs do not require finger movement or grasping.

In accordance with the invention a cellular telephone 26 having an integral antenna is placed in a back pack 27 mounted on the backrest 18. The cellular telephone is provided with a “car kit” unit 28 which provides hands-free, voice-activated dialing of a library of stored telephone numbers. In a typical case the system is capable of storing up to 20 numbers which can be dialed on voice-command after suitable programming and training of the unit.

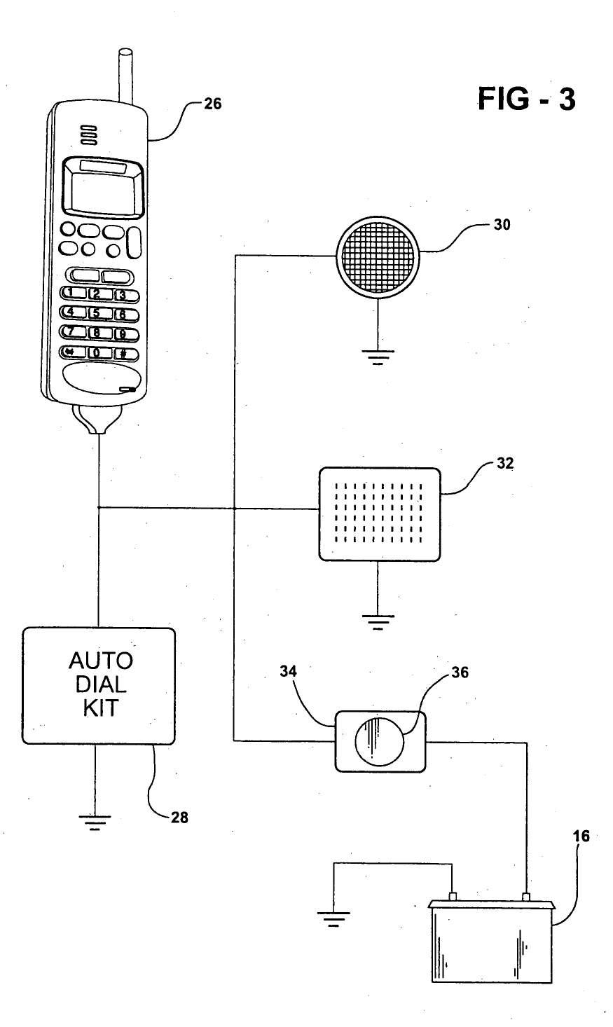

A microphone 30 is mounted in a socket in the left armrest and a speaker 32 is mounted under the right armrest and interconnected by wiring 38 to the hands-free voice-activated car kit 28 along with the microphone 30. As shown in FIG. 3 the entire electrical system is connected to one or both of the 12-volt batteries 16 through a toggle-type activation switch 34 having a spring biased push button 36 mounted under the left armrest 22; i.e., the armrest to which the joystick control 20 is attached and facing outwardly where it may be engaged and depressed by a bumping action of the wrist or hand heel of the operator. The term “toggle switch” is used herein to denote a switch which makes a circuit when depressed a first time, returns to the extended position by virtue of a return spring, and breaks the circuit when depressed a second time. Switch 34 performs the switching functions normally perform ed by the hinged “flip” cover of a conventional phone; i.e., pressing button 36 once is the equivalent of opening the “flip” cover and pressing the button 36 again is the equivalent of closing the cover. Switch 34 is placed on the left armrest in this case because of the preestablished fact that the user of this particular chair has control over movements of his/her left arm. Switch 34 can, however, be placed in any of several other locations where it can be operated to turn the cellular telephone system on and off by movement of a large body part of the occupant of the chair 10. For example, the switch can be mounted on a headrest where the push button 36 can be activated by head movement. A voltage conversion circuit 42 is provided to convert 12 or 24 volts to the 5 or 9 volts needed for the telephone system components.

The chair 10 has a recharging plug 40 connected to a retractable cord for recharging the battery 16. Since the cell phone 26 is connected to be powered by one of the batteries 16, it is good practice to remove the integral metal hydride battery which is associated with the otherwise conventional cell phone 26.

In operation, an occupant of the chair 10 uses his or her left arm to depress the push button 36 of the switch 34 to turn the telephone system on in preparation for initiating or receiving a call. The auto dial unit 28 produces a voice output through the speaker 32 asking the occupant if he or she wishes to make a call and, if so, to identify the person or place to be called. A voice command from the occupant is picked up by microphone 30 and transmitted to the auto dial unit 28 to dial the number through the transmitter portion of the cellular telephone 26. After the connection is made, the call proceeds in the normal fashion, the occupant's voice being transmitted through the microphone 30 and the callee's voice being transmitted back to the occupant through the speaker 32. At the conclusion of the call, the occupant depresses the push button 36 of the switch 34 to terminate the call in the normal fashion. Repeat depression of the push button 36 is accomplished to initiate the next call.

It will be apparent that the telephone system, as a result of being connected to the large capacity drive battery 16, can be operated for long periods of time with no concern over a low battery condition. In other words, the electrical powered telephone system comes from the same battery which provides the drive and as long as the chair has drive power, the telephone system also has electrical power.

Through the use of the switch 34 or an equivalent “triggering” device, the occupant is relieved of the necessity for operating any of the mechanical aspects of the cellular telephone 26; i.e., it is not necessary to depress a push button or manipulate a “flip” feature to initiate or terminate a call. Instead a simple large push button; i.e., a push button having a diameter on the order of ⅜″ to ½″, is depressed by the movement of any large body part over which the occupant of the chair has control. In this instance that body part is the left arm which is the same body part used to manipulate the cradle-type joystick 20 for control of the chair.

The telephonic system uses conventional components which are available either from the cellular telephone system manufacturer and/or a local electronics shop such as Radio Shack.

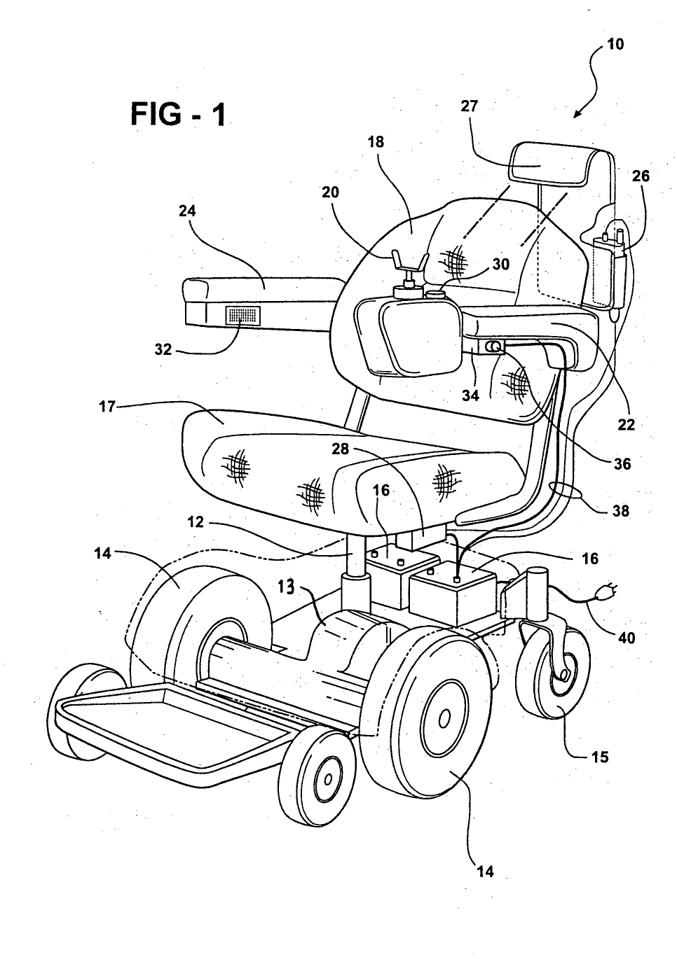

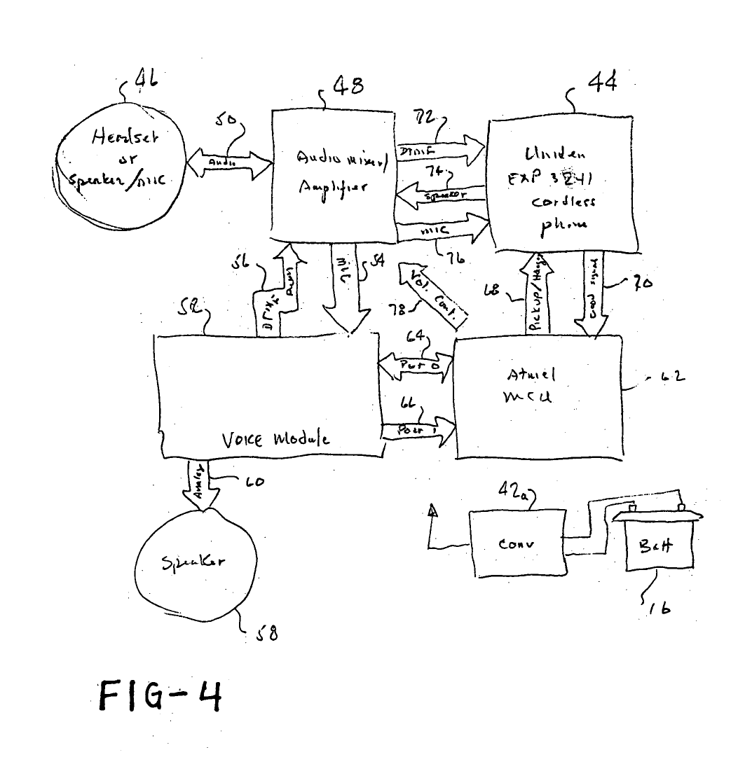

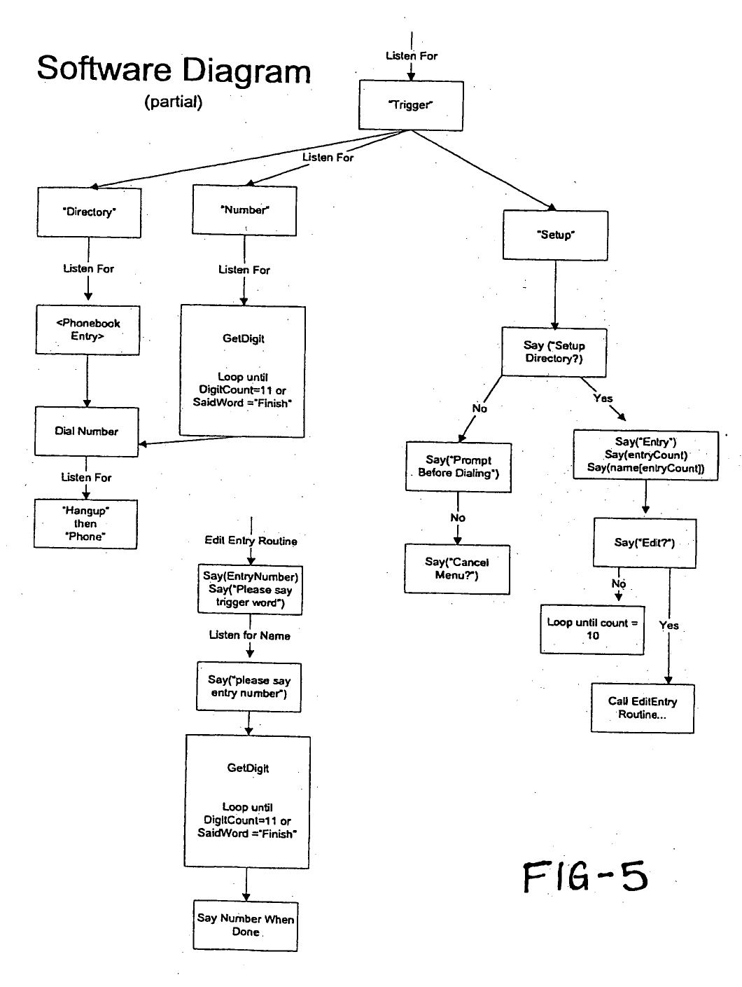

Referring now to FIGS. 4 and 5, a second embodiment of the invention utilizing a Uniden EXP3241 cordless phone 44 will be described. As shown in FIG. 4, Uniden cordless phone is part of a system further comprising a headset 46 which includes a pair of speakers and a microphone. Alternatively, the headset 46 may be “disassembled” and the speakers and headset are mounted on the wheelchair 10 of FIG. 1 in essentially the manner described with reference to the first embodiment. The headset 48 is connected to an audio mixer/amplifier unit 48 by way of a two-way audio link 50. Unit 48 is connected to the unit and cordless phone 44 by way of a DTMF link 72 and audio speaker activation link 74 and a microphone input link 76.

The system of FIG. 4 further comprises a voice module such as the “voice extreme” module available from Century Inc., a unit which includes a large flash ROM and a proprietary inner circuit. The connection between unit 48 and the voice module 52 is made by way of a microphone input link 54 and a DTMF pulse width modulated audio output link 56. Unit 52 is connected to a voice-response speaker by way of an audio analog link 60.

The system further comprises an Atmel “Atmega 8” MCU operating in the 4 megahertz range and interconnected with the unit in telephone by way of a pick up/hang up data link 68 and a data link 70 indicating the presence of a useable signal. Volume control link 78 may also be provided.

The system is powered from the 24 volt battery system 16 through a voltage conversion circuit 42a which may include an invertor to provide AC power to the appropriate components.

In operation, a cordless system is activated by means of a “trigger” signal, which enters the system through the microphone 46 and the audio link 50 to the audio mixer/amplifier 48. That signal, when amplified, is applied through the microphone data link 54 to the voice module 58 where it turns on the telephone by way of link 66 and the Atmel MCU 62. This produces the “pick-up” signal on data link 68 which effectively turns the phone 44 on. Thereafter, a dialing command can be generated in the normal fashion; i.e. as described above with reference to the “hands free” system of the first embodiment. A representative flow chart for software useable in an illustrative embodiment of the device of FIG. 4 is shown in FIG. 5 of the drawings.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. A powered wheelchair with wireless telephonic capability comprising:
an electrically powered wheelchair having a dc drive, a seating structure, a backrest, opposed armrests and a maneuvering control element;
a battery unit for supplying electrical energy to the dc drive;
a wireless telephone having a voice-activated dialing capability and including microphone and speaker components carried by the wheelchair;
a hands-free dialing system carried by the wheelchair and connected to the telephone for receiving and executing voice dialing instructions when enabled, and
trigger means mounted on the chair structure and responsive to an occupant command to power up the dialing system and enable said system to receive a dialing command.

2. The apparatus described in claim 1 wherein the microphone is mounted in one of the armrests.

3. The apparatus as described in claim 1 wherein the speaker is mounted in one of the armrests.

4. The apparatus as described in claim 1 wherein the enable switch is mounted on the one armrest and accessible to the arm of the occupant used for maneuvering controls.

5. The apparatus as defined in claim 4 wherein the enable switch is mounted under the one armrest and includes a spring bias push button which faces laterally outwardly from the one armrest.

6. A combination of an electrically-powered wheelchair and a wireless telephone for use by an occupant of the wheelchair comprising:
a wheelchair having wheels, a drive unit operatively connected to the wheel, a seating structure including a backrest and opposing armrests, and a control element for use by the occupant in controlling the drive unit;
a 24-volt battery unit mounted on the wheelchair and connected to the drive unit for powering same;
a two-way wireless telephone for use by an occupant in making and receiving calls and being carried by the wheelchair and comprising a microphone unit, a speaker unit and a voice-activated dialing system carried by the wheelchair; and
occupant-activated trigger means for enabling the voice-activated dialing system;
all said wireless telephone and voice-activated dialing being provided with DC power by the battery unit when enabled by the trigger means for extended operating life.

7. The combination described in claim 6 wherein the microphone is mounted in one of the armrests.

8. The combination described in claim 6 wherein the speaker is mounted on one of the armrests.

9. The combination described in claim 6 wherein the occupant-activated trigger means for enabling comprises a push button mounted on an armrest for activation by the occupant.
